(19) United States
(12) Patent Application Publication
(10) Pub. No.: US 2023/0024433 A1
(43) Pub. Date: Jan. 26, 2023

(54) OPTICAL COMPONENTS HAVING ATHERMALIZATION AND ABERRATION CORRECTION CHARACTERISTICS

(71) Applicant: Meta Platforms Technologies, LLC, Menlo Park, CA (US)

(72) Inventors: Zhisheng YUN, Sammamish, WA (US); Byron TAYLOR, Sammamish, WA (US); Tamer ELAZHARY, Redmond, WA (US); Ning Yueng CHAN, Seattle, WA (US); Fei LIU, Los Altos, CA (US)

(73) Assignee: Meta Platforms Technologies, LLC, Menlo Park, CA (US)

(21) Appl. No.: 17/379,690

(22) Filed: Jul. 19, 2021

(51) Int. Cl. G02B 7/02; G02B 9/62; G02B 3/00; G02B 27/00

(52) U.S. Cl. CPC G02B 7/028; G02B 9/62; G02B 7/021; G02B 3/00; G02B 27/0025; G02B 27/0172

(57) ABSTRACT

According to examples, a system for designing optical components to provide passive athermalization and aberration correction is described. The system may include a processor and a memory storing instructions. The processor, when executing the instructions, may cause the system to select one or more optical elements to be included in the optical component based on the received design specifications, select one or more optical element configurations based on the selected one or more optical elements and implement an optimization function to optimize the selected one or more optical element configurations. The processor, when executing the instructions, may then determine if the one or more optical element configurations meet one or more initial specifications, enable one or more adjustment(s) to the one or more optical element configurations and determine if an optical element configuration meet one or more additional specifications.

### TECHNICAL FIELD

This patent application relates generally to optics and optical components, and more specifically, to systems and methods for designing optical components, including multi-element optical components, that may provide passive athermalization and aberration correction over an entire field of view (FOV).

### BACKGROUND

The proliferation of augmented reality (AR), virtual reality (VR), and mixed reality (MR) devices has created an ever-increasing demand for sophisticated optical components. However, various issues may arise that can affect the performance of these optical components. For example, heat or temperature fluctuations can create problems, such as optical defocusing. Optical defocusing may be positional shift of an optical component due to change in ambient temperature or other temperature-related cause. Such a positional change may affect the accuracy or reliability of the optical components.

Another issue that is typically encountered is achromatism. Achromatism may include instances where chromatic aberration associated with an optical component may affect image quality. In some instances, these issues may cause an image to become blurry or distorted. For a user of an optical device including such an optical component, this may result in viewing fatigue, dizziness, or other adverse conditions.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a singlet lens, according to an example.

FIG. 2 illustrates a table of specifications that a singlet lens may utilize, according to an example.

FIG. 3A illustrates a block diagram of a barrel-in-barrel lens configuration, according to an example.

FIG. 3B illustrates a block diagram of a barrel-in-barrel lens configuration, according to an example.

FIG. 4 illustrates a block diagram of a doublet lens.

FIG. 5 illustrates a diagram of focal shift results from a plastic doublet versus focal shift results for a plastic singlet, according to an example.

FIG. 6A illustrates a block diagram of a system environment, including a system, that may be implemented to design optical components, including multi-element optical components, that may provide passive athermalization and aberration correction over an entire field of view (FOV), according to an example.

FIG. 6B illustrates a block diagram of the system that may be implemented to design optical components, including multi-element optical components, that may provide passive athermalization and aberration correction over an entire field of view (FOV), according to an example, according to an example.

FIG. 7 illustrates a table including various materials that may be used in fabrication of a multi-element optical component, according to an example.

FIG. 8 illustrates a table including specifications of various materials that may be used in fabrication of a multi-element optical component, according to an example.

FIG. 9A illustrates graph of focus shift versus optical transfer function for a multi-element optical component at 0 degrees (0°), according to an example.

FIG. 9B illustrates graph of focus shift versus optical transfer function for a multi-element optical component at 35 degrees (35°), according to an example.

FIG. 9C illustrates a graph of focus shift versus optical transfer function for a multi-element optical component at 65 degrees (65°), according to an example.

FIG. 10 illustrates a diagram of a plurality of zones that may be utilized in implementing an athermalization requirement, according to an example.

FIG. 11 illustrates a block diagram of an arrangement of optical elements that may be included in an optical element configuration, according to an example.

FIG. 12 illustrates a method to design optical components, including multi-element optical components, that provide may passive athermalization and aberration correction over an entire field of view (FOV), according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As described above, temperature fluctuations and achromatism may cause adverse effects on optical components. Optical shifting and aberrations that result from heat or achromatism may be mitigated by designing optical components to be more resistant to temperature change, which may be referred to as “athermalization.” It should be appreciated that athermalization may be “active” or “passive.”

Active athermalization may be provided by a physical means that may be designed to counter effects of a temperature increase. For example, a physical device or component may be used to adjust a first optical element (e.g., a sensor) and/or a second optical element (e.g., a lens) to actively counter the effects of the temperature increase. One such example may be a voice coil magnetism motor (VCM), and another example may be a piezoelectric motor (PZT).

However, it should be appreciated that such active athermalization techniques may present their own issues. In some instances, a physical component may be an additional component that increases weight or size of an optical device, which in turn may increase bulkiness of the optical device, decrease comfort for a user (who may be wearing a headset having these components), or render the optical device unusable altogether. In other instances, the physical component may interfere with operation of other components and may limit, hinder, or degrade performance.

Passive athermalization may be provided by designing an optical component to inherently and/or automatically adjust to (i.e., counter) effects of a temperature increase. For example, an optical component may be designed having a shape and/or made with a material that may help achieve some level of athermalization. In another example, an optical component may be designed such that an effect of a temperature increase on a first optical component may adjust/counter an effect of the temperature increase on a second optical component.

Typically, an optical component may be made of a variety of materials. It should be appreciated that selection of materials during a design process may significantly impact performance of the optical component. One such material may be plastic, which may be desirable due to cost-effectiveness during fabrication (i.e., molding). However, plastic may also possess other characteristics that may not be as suited for countering effects of temperature increase. For example, plastic may have a large variation in a refractive index with respect to variation(s) in ambient temperature. In some examples, a refractive index (also known as refraction index or index of refraction) may indicate how fast light may travel through the material. The variation in refractive index with respect to a variation in temperature may be indicated as “dn_{T}/dT”. Also, plastic may typically possess a large coefficient of thermal expansion (CTE). In some examples, the coefficient of thermal expansion (CTE) may indicate how a size of an object may change with a change in temperature. For these reasons, in some examples, plastic may be more sensitive to temperature than other materials.

Another such material used in fabrication of optical components may be glass. Glass may typically exhibit a lower variation in refractive index with respect to a variation in temperature (dn_{T}/dT) and a lower coefficient of thermal expansion (CTE). However, a drawback of utilizing glass in design of optical components may be that glass may be heavier, for example, than plastic. This may mean that adding glass to an optical may make it more uncomfortable for a user during use. In addition, another drawback of utilizing glass may be that it may be difficult to manipulate (i.e., mold). This may restrict its applicability in certain instances where precise where the optical component may require a particular shape or contour.

Accordingly, it should be appreciated that material selection and design associated with an optical component may be a complex and inter-connected process. Aspects of design and manufacture of optical components are discussed further below.

Systems and methods for providing optical components that may provide passive athermalization and aberration correction characteristics over an entire field of view (FOV) are provided. In some examples, the optical components may be comprised of multiple elements, each having their own physical characteristics. Moreover, in some examples, the optical components may be comprised of various materials, which may be selected to passively provide athermalization and aberration correction characteristics.

In some examples and as discussed further below, to select and/or design a plurality of optical elements for an optical component, the systems and methods described may divide an object space into a plurality of sub-zones. In addition, in some examples, the systems and methods may enable generation of an optimization operand that may select and/or design one or more of the plurality of optical elements to satisfy the athermalization and aberration correction characteristics and/or requirements. Furthermore, in some examples, the systems and methods may provide athermalization by selecting a plurality of optical elements based on optical power characteristics and optimizing each of a plurality of sub-zones, such as zone1, zone2, . . . zone n, to provide an improved athermalization and aberration-correction design.

In some examples, to design an optical component with multiple elements as described, each of the multiple elements may be analyzed and selected according to various criteria. In some examples, the criteria may be related to focus power ϕ, athermalization and/or achromatism. In some examples, each of the multiple elements may be selected to satisfy the following athermalization characteristic:

$$- {( \frac{1}{{φ}_{k}} )}^{2} {\sum }_{i}^{n} {( \frac{{h}_{k i}}{{h}_{k 1}} )}^{2} {γ}_{i} {φ}_{k i} - α L = 0 .$$

In some examples, φₖ may be the required entire lens group optical power at zones, L may be a barrel length, α may be the barrel coefficient of the thermal expansion (CTE) and hₖ₁ may be the marginal ray height at zoneₖ at a first element of the multiple elements of the optical component. In some examples, the above athermalization characteristic may be implemented and satisfied at each sub-zone of an object space.

### Focal Shift

In some instances, focal shift (or “focal length shift”) in an optical component may occur when an ambient temperature of an optical component may vary over a range of temperature(s). In particular, in some examples, focal shift may occur when particular geometric dimensions associated with an optical component (e.g., radius, thickness, etc.) may change.

In some examples, a focal length shift (also referred to as “defocus”) of a lens Δf with respect to a variation in temperature T may be calculated as follows:

$$Δ f ( T ) = {f}_{0} * ( 1 + ( {α}_{l e n s} - \frac{\frac{{dn}_{T}}{dT}}{{n}_{0} - 1} ) * Δ T )$$

In some examples, f₀ may be a nominal focal length of a lens and αₗₑₙₛ may be a coefficient of thermal expansion (CTE) of the lens. In these examples, dn_{T}/dT may be the variation (i.e., derivative) of an refractive index with respect to a variation in temperature T, n₀ may be a refractive index of the lens material at nominal temperature and ΔT may a change in (ambient) temperature.

Furthermore, in these example, a thermal refractive coefficient γ of the lens may be calculated as follows:

$$γ = {α}_{lens} - \frac{\frac{{dn}_{T}}{dT}}{{n}_{0} - 1} .$$

Accordingly, the above equation associated with the a focal length shift with respect to temperature Δf(T) may be rewritten as follows:

Δf(T)=f₀*(1+γΔT).

In some examples, a lens barrel may be used to hold and/or support a lens. In these instances, a variation in length L(T) of a lens barrel with temperature represented by may be calculated as follows:

L(T)=L₀*(1+α_{barrel}*ΔT).

In some examples, L₀ may be the nominal barrel length at an particular temperature (e.g., 20 degrees) and α_{barrel} may be a coefficient of thermal expansion (CTE) of the barrel material.

Also, in some examples, a focal length shift with respect to temperature Δf(T) may be equal to a difference of the focal length and a length of a lens barrel, and may be calculated as follows:

$$Δ f ( T ) = f ( T ) - L ( T ) = {f}_{0} * ( 1 + ( {α}_{lens} - \frac{\frac{{dn}_{T}}{dT}}{{n}_{0} - 1} ) * Δ T ) - {L}_{0} * ( 1 + {α}_{b a r r e l} * Δ T ) .$$

It should be appreciated that defocus Δf(T) may be minimized where a nominal barrel length L₀ may be close or equal to a nominal focal length f₀. In these instances, the defocus Δf(T) equation may can be further simplified (i.e., approximated) as follows:

$$Δ f ( T ) \approx {f}_{0} Δ T ( ( {α}_{lens} - \frac{\frac{{dn}_{T}}{dT}}{{n}_{0} - 1} ) - {α}_{barrel} ) .$$

Furthermore, a calculation of defocus Δf(T) may again be simplified if a lens barrel may have a same or similar coefficient of thermal expansion (CTE) as a lens. In some instances, a nominal focal length of a lens may be approximately equal to a lens barrel length at a nominal temperature. In these instances, a “telephoto ratio” (i.e., a ratio of the nominal focal length of a lens and a lens barrel length at a nominal temperature) may be approximately equal to one. Where a telephoto ratio may be approximately equal to one, the defocus Δf(T) may be simplified as follows:

$$Δ f ( T ) \approx {f}_{0} Δ T * ( - \frac{\frac{{dn}_{T}}{dT}}{{n}_{0} - 1} ) .$$

From the above equation, it should be appreciated that defocus Δf(T) may be proportional to a nominal focal length f₀ of a lens and a derivative dn_{T}/dT of a refractive index relative to temperature T. Furthermore, it should also be appreciated that Δf(T) may be inversely proportional to the refractive index of a lens material at nominal temperature n₀. Accordingly, it may follow that to design a lens minimally sensitive to temperature, it may be desirable to utilize a lens having a small(er) focal length f₀ that be made of a material having a small(er) derivative dn_{T}/dT of the refractive index relative to temperature T and a large(r) refractive index n₀.

### Focal Shift Characteristics in a Plastic Singlet

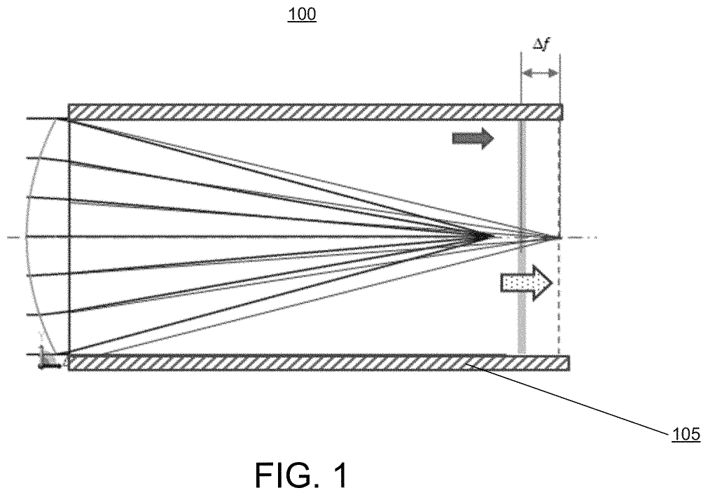

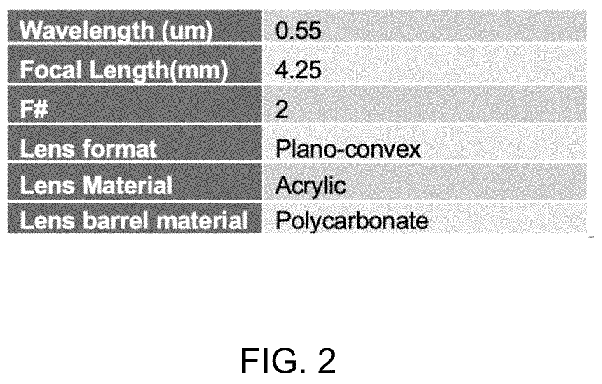

In some examples, a simple lens or “singlet” may be analyzed to determine optical characteristics. FIG. 1 illustrates a block diagram of a singlet 100. FIG. 2 illustrates a table of specifications that the singlet 100 may utilize. These specifications may include wavelength, focal length, F# (described further below), lens format, lens material and lens barrel material. In some examples, the singlet 100 may include a lens barrel 105.

So, in these examples, it may be observed that over a temperature change from −25° C. to 85° C., if the coefficient of thermal expansion (CTE) of the lens barrel material may be 285×10e⁻⁶ (m/mK⁻¹), the singlet 100 may have very small focal shift (<1.0 um). In addition, in some examples, it may also be observed that a focal shift of the singlet 100 may exceed an expansion of the lens barrel 105 when the temperature may remain above (a nominal) 20° C. Furthermore, in some examples, the focal shift of the singlet 100 may (inversely) remain shorter than that of the lens barrel 105 when the temperature may drop below the (nominal) 20° C. Accordingly, in some examples, a focal shift Δf(T) as a function of temperature T may be calculated as follows:

$$Δ f ( T ) \approx {f}_{0} Δ T * ( - \frac{\frac{{dn}_{T}}{dT}}{{n}_{0} - 1} ) .$$

It should be appreciated that, in these examples, the focal shift Δf(T) of the singlet 100 may be related to the derivative dn_{T}/dT of the refractive index relative to temperature T.

It the case of glass (e.g., BK7), it should be appreciated that in some examples, a glass singlet may have a much smaller focal shift than that of a plastic singlet. In these examples, this may be so because the glass singlet may have a smaller coefficient of thermal expansion (CTE) than that of a lens barrel material and may have a small (and positive) derivative dn_{T}/dT of the refractive index relative to temperature T. Accordingly, in some examples, a focal shift for a glass singlet may be calculated as follows:

$$Δ f ( T ) \approx {f}_{0} Δ T ( ( {α}_{lens} - \frac{\frac{{dn}_{T}}{dT}}{{n}_{0} - 1} ) - {α}_{barrel} ) .$$

Furthermore, in some examples, since the derivative dn_{T}/dT of the refractive index relative to temperature T of the glass singlet may positive when temperature may increase, the focal shift Δf(T) of the glass singlet may decrease. In some examples, this may mean that a focal length shift caused by a coefficient of thermal expansion (CTE) and a focal shift caused by a derivative dn_{T}/dT of the refractive index relative to temperature T may be opposed, and therefore may neutralize each other. For at least this reason, focal shift in a glass singlet may typically be less than in a plastic singlet.

### Athermalization Characteristics for a Plastic Lens

Various properties of plastic may be utilized to achieve athermalization of a plastic lens. For example, for at least the reasons discussed above, athermalization in a plastic lens may require a barrel having a larger (an often significantly larger) barrel than that of a glass lens. Indeed, in some examples, it may be observed that a plastic material used for a lens may require a coefficient of thermal expansion (CTE) above 285×10⁻⁶/T⁻¹. That is, in some instances, a plastic singlet may require a large(r) coefficient of thermal expansion (CTE) of a lens barrel to achieve athermalization. Unfortunately, however, in some instances, it may be difficult to secure plastic that may possess such a large coefficient of thermal expansion (CTE).

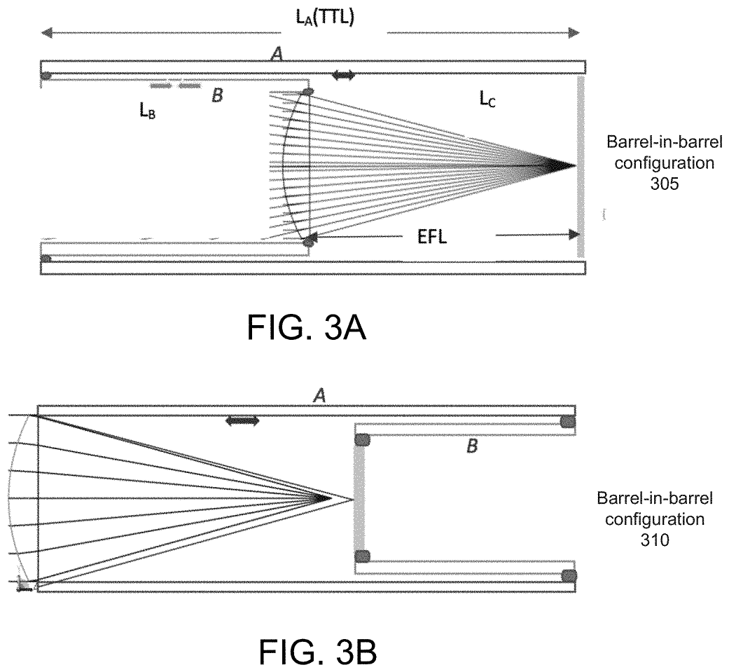

In some examples, one way to compensate for a large focal shift generated by a plastic lens may be to increase a barrel length. Moreover, in some examples, to compensate for a large focal shift provided by use of a plastic lens, a second barrel with a different coefficient of thermal expansion (CTE) may be utilized. These configurations may also be referred to as a “barrel-in-barrel” or “multi-barrel” configuration. A first example of a barrel-in-barrel configuration 305 is shown in FIG. 3A, and a second barrel-in-barrel configuration 310 is shown in FIG. 3B. In some instances, such barrel-in-barrel configurations may compensate for a focal shift by holding an image sensor in position at a correct focal plane.

In some examples, to achieve athermalization, the following design considerations may be provided. First, a first barrel may require a larger coefficient of thermal expansion (CTE) and a second barrel may require a smaller coefficient of thermal expansion (CTE). Next, in an instance where a coefficient of thermal expansion (CTE) of second barrel may be zero, a length of a first barrel may need to be longer (e.g., approximately 4-5× longer) than a focal length that which may be provided by use of a single barrel with having a high coefficient of thermal expansion (CTE). Also, in examples where a second barrel may exhibit negative expansion (i.e., the barrel may shrink as temperature may rise), a length of a first barrel may be made shorter. Furthermore, if a telephoto ratio may be less than one, a lens barrel may require a large coefficient of thermal expansion (CTE) (e.g., >285×10e⁻⁶), and a second barrel may not be required.

### Athermalization Characteristics of a Glass Lens

In some examples, a glass lens may be configured for athermalization as well. Similar to the example of the plastic singlet described above, a glass lens may utilize a barrel-in-barrel configuration. Moreover, in some examples, a material of an inside barrel of a barrel-in-barrel configuration may be chosen having a small(er) coefficient of thermal expansion (CTE). In these examples, an outside barrel of the barrel-in-barrel configuration may be chosen having a small(er) coefficient of thermal expansion (CTE) material as well. In other examples, a material of an inside barrel of a barrel-in-barrel configuration may be chosen having a large(r) coefficient of thermal expansion (CTE). In these examples, an outside barrel of the barrel-in-barrel configuration may be chosen having a large(r) coefficient of thermal expansion (CTE) material as well. In some examples this may be because, as discussed above, glass may have a small(er) variation in focal shift with respect to a change in temperature. It should further be appreciated that, as a glass lens may not be as sensitive to a change in temperature, a telephoto ratio of less than one may be easier to achieve. Furthermore, in some examples, athermalization in a glass singlet may be easier as glass may typically have a small(er) coefficient of thermal expansion (CTE), and a derivative dn_{T}/dT of the refractive index relative to temperature T. Indeed, in some instances, a ratio of the derivative dn_{T}/dT of the refractive index relative to temperature T may even be positive.

### Design Considerations for a Multi-Element Component

As discussed further below, design considerations for an optical component with multiple elements (i.e., “multi-element”) may include focus power ϕ, athermalization and achromatism. In some examples, focus power in a multi-element optical component (e.g., a multi-element lens) may be calculated as follows:

$$φ = {\sum }_{i}^{k} φi ,$$

$$and$$

$$φ = {φ}_{F} - {φ}_{C} = {\sum }_{i}^{k} \frac{{φ}_{i}}{{V}_{i}} = 0 .$$

Furthermore, a ratio of focal shift to a change in temperature in a multi-element optical component may be calculated as follows:

$$\frac{Δ f}{Δ T} = - {( \frac{1}{φ} )}^{2} {\sum }_{1}^{k} {γ}_{i} {φ}_{i} = {α}_{h} {L}_{0} .$$

In some examples, αₕ may be a coefficient of thermal expansion (CTE) for a lens barrel, L₀ may be a barrel length and Vᵢ may be an Abbe number of the material selected. Also, in some examples, an Abbe number may indicate a dispersion of an optical material, wherein a high(er) Abbe number value may indicate a lower dispersion.

In some examples, a doublet may provide greater thermal stability. For example, as discussed further below, in some examples, a plastic and glass (i.e., mixed material) doublet may be designed to achieve athermalization.

Design Considerations Associated with an “Attached” Multi-Element Component

In some examples, a multi-element component may be “attached” in that two or more of the multiple elements may be physically attached to each other. One example of an attached multi-element component may be a doublet. In some examples, a doublet may be a type of lens made up of two simple lenses paired together.

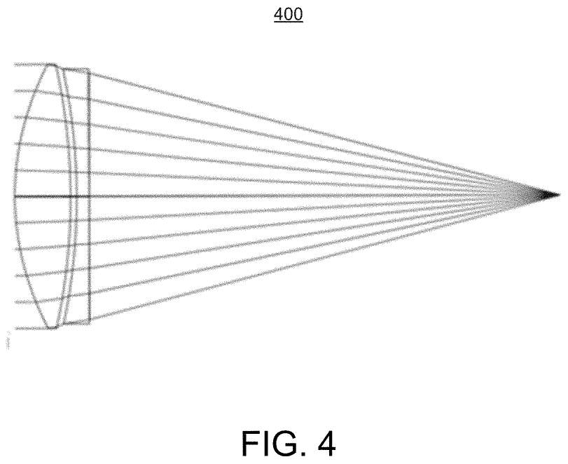

FIG. 4 provides an illustration of a doublet 400. In a doublet configuration, design requirements of focus power, achromatic and athermalization may be calculated. In some examples, focus power and a focal shift in a doublet may be calculated as follows:

$$φ = {φ}_{1} + {φ}_{2} ,$$

$$and$$

$$Δ {f}_{F C} = {( \frac{1}{φ} )}^{2} ( \frac{{φ}_{1}}{{V}_{1}} + \frac{{φ}_{1}}{{V}_{2}} ) = 0 .$$

Furthermore, a ratio of focal shift to a change in temperature in a multi-element optical component may be calculated as follows:

$$\frac{Δ f}{Δ T} = - {( \frac{1}{φ} )}^{2} ( {γ}_{1} {φ}_{1} + {γ}_{2} {φ}_{2} ) = {α}_{h} {L}_{0} .$$

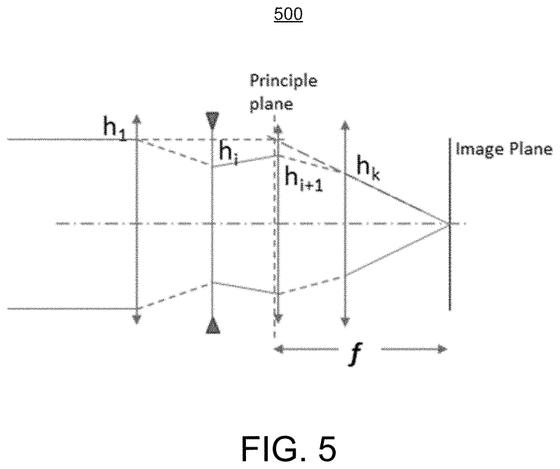

FIG. 5 illustrates focal shift results 500 from a plastic doublet versus focal shift results for a plastic singlet. In this instance, both the plastic doublet and the plastic singlet had specifications as shown in FIG. 2.

In some examples, it may be observed that a focal shift of plastic doublet may be smaller at −25° C. (e.g., 4 micron (4 μm) smaller) and smaller at 85° C. (e.g., 5.0 micron (5 μm) smaller) than that of a plastic singlet having similar characteristics. In some instances, this may be because as temperature may rise, a focal length decrease of a first element may cancel a focal length increase of a second element. Accordingly, in some examples, a “total” shift of a plastic doublet may be smaller than that of a plastic singlet.

Nevertheless, it should be appreciated that since thermal characteristics of materials of the plastic doublet may be similar, athermalization characteristics may remain unsatisfactory. Indeed, in some instances, a plastic doublet may not meet athermalization design requirements because there may limited options of plastic materials that may be utilized, and thermal characteristics of these options may be too similar. On the other hand and as discussed further below, it may also be observed that a doublet lens with one or more plastic elements combined with and one or more glass elements may satisfy an athermalization requirement over a particular temperature range.

Design Consideration Associated with a “Separated” Multi-Element Optical Component

In some examples, for a separated multi-element optical component, an initial design requirement may be calculated as follows:

$$φ = \frac{1}{f} = {φ}_{1} + \frac{{h}_{2}}{{h}_{1}} {φ}_{2} + \frac{{h}_{3}}{{h}_{1}} {φ}_{3} + … + \frac{{h}_{k}}{{h}_{1}} {φ}_{k} = {\sum }_{i}^{i} \frac{{h}_{i}}{{h}_{1}} {φ}_{i} .$$

In some examples, effective power of each element included in a separated multi-element optical component may be calculated as follows:

$${φ}_{i}^{′} = \frac{{h}_{i}}{{h}_{1}} {φ}_{i} .$$

Also, in some examples, an Abbe number and a coefficient of thermal expansion (CTE) of each element included in a separated multi-element optical component may be calculated as follows:

$${V}_{i}^{′} = \frac{{h}_{1}}{{h}_{i}} {V}_{i} ,$$

$$and$$

$${γ}_{i}^{′} = \frac{{h}_{i}}{{h}_{1}} {γ}_{i} .$$

Furthermore, for a separated multi-element optical component, to meet the requirements of the focus power ϕ, athermalization and achromatism, design requirements may be provided as follows:

$$\begin{matrix}φ = {\sum }_{i}^{k} & {φ}_{i}^{′} = {\sum }_{i}^{k} & \frac{{h}_{i}}{{h}_{1}} {φ}_{i} ,\end{matrix}$$

$$\begin{matrix}\frac{Δ f}{Δ T} = - {( \frac{1}{φ} )}^{2} {\sum }_{1}^{k} & {γ}_{i}^{′} {φ}_{i}^{′} = - {( \frac{1}{φ} )}^{2} {\sum }_{i}^{k} & {( \frac{hi}{h 1} )}^{2}\end{matrix} {γ}_{i} {φ}_{i} = {α}_{h} {L}_{0} ,$$

$$and$$

$$\begin{matrix}φ = {φ}_{F} - {φ}_{C} = {\sum }_{i}^{k} & \frac{{φ}_{i}^{′}}{{V}_{i}^{′}} = {\sum }_{i}^{k} & {( \frac{hi}{h 1} )}^{2}\end{matrix} \frac{{φ}_{i}}{{V}_{i}} = 0.$$

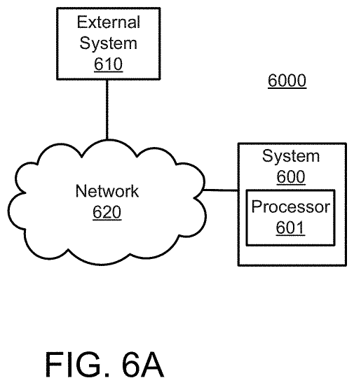

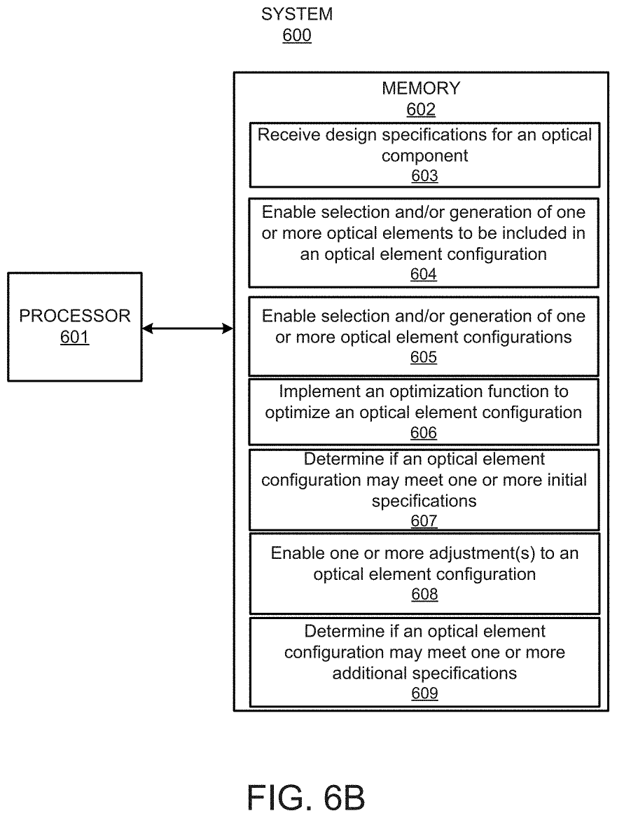

Reference is now made to FIGS. 6A-B. FIG. 6A illustrates a block diagram of a system environment, including a system, that may be implemented to design optical components, including multi-element optical components, that may provide passive athermalization and aberration correction over an entire field of view (FOV). FIG. 6B illustrates a block diagram of the system that may be implemented to design optical components, including multi-element optical components, that may provide passive athermalization and aberration correction over an entire field of view (FOV).

As will be described in the examples below, one or more of system 600, external system 610 and system environment 6000 shown in FIGS. 6A-B may be operated by a service provider to fabricate and/or implement an optical device. It should be appreciated that one or more of the system 600, the external system 610 and the system environment 6000 depicted in FIGS. 6A-B may be provided as examples.

While the servers, systems, subsystems, and/or other computing devices shown in FIGS. 6A-B may be shown as single components or elements, it should be appreciated that one of ordinary skill in the art would recognize that these single components or elements may represent multiple components or elements, and that these components or elements may be connected via one or more networks. The middleware may include software hosted by one or more servers.

In some examples, the external system 610 may include any number of servers, hosts, systems, and/or databases that store data to be accessed by the system 600 and/or other network elements (not shown) in the system environment 6000. In addition, in some examples, the servers, hosts, systems, and/or databases of the external system 610 may include one or more storage mediums storing any data.

The system environment 6000 may also include the network 620. In operation, one or more of the system 600 and the external system 610 may communicate with one or more of the other devices via the network 620. The network 620 may be a local area network (LAN), a wide area network (WAN), the Internet, a cellular network, a cable network, a satellite network, or other network that facilitates communication.

It should be appreciated that in some examples, and as will be discussed further below, the system 600 may be configured to utilize various techniques and mechanisms to design optical components, including multi-element optical components, that provide may passive athermalization and aberration correction over an entire field of view (FOV). Details of the system 600 and its operation within the system environment 6000 will be described in more detail below.

As shown in FIGS. 6A-B, the system 600 may include processor 601 and the memory 602. In some examples, the processor 601 may be configured to execute the machine-readable instructions stored in the memory 602. It should be appreciated that the processor 601 may be a semiconductor-based microprocessor, a central processing unit (CPU), an application specific integrated circuit (ASIC), a field-programmable gate array (FPGA), and/or other suitable hardware device.

In some examples, the memory 602 may have stored thereon machine-readable instructions (which may also be termed computer-readable instructions) that the processor 601 may execute. The memory 602 may be an electronic, magnetic, optical, or other physical storage device that contains or stores executable instructions. The memory 602 may be, for example, Random Access memory (RAM), an Electrically Erasable Programmable Read-Only Memory (EEPROM), a storage device, an optical disc, or the like.

The memory 602, which may also be referred to as a computer-readable storage medium, may be a non-transitory machine-readable storage medium, where the term “non-transitory” does not encompass transitory propagating signals. It should be appreciated that the memory 602 depicted in FIGS. 6A-B may be provided as an example. Thus, the memory 602 may or may not include additional features, and some of the features described herein may be removed and/or modified without departing from the scope of the memory 602 outlined herein. It should be appreciated that, and as described further below, the processing performed via the instructions on the memory 602 may or may not be performed, in part or in total, with the aid of other information and data.

As used herein, an “optical component” may include any device or component that may be utilized to manipulate (e.g., focus, disperse, etc.) a light beam. In some examples, the optical component may include an arrangement of one or more lenses. In one example, the optical component may be included and utilized in an optical device, such as an virtual reality (VR) headset.

In some examples, and as discussed further below, the optical component may include one or more elements. That is, as used herein, an “element” or “optical element” may include any item that may be included in a optical component. In one example, the optical element may consist of a single lens element that may be one of a plurality of lens elements to be included in a lens component.

Also, as used herein, an “optical element configuration” may include an arrangement or setting of one or more optical elements. So, in one example, a plurality of optical elements (e.g., lens elements) may be selected or arranged to comprise an optical component. As discussed further below, in some examples, an optical element configuration may be selected and/or arranged with respect to one or more requirement(s), such as an athermalization requirement and/or an achromatism requirement.

In some examples, the memory 602 may store instructions, which when executed by the processor 601, may cause the processor to: receive 603 design specifications for an optical component; enable 604 selection and/or generation of one or more optical elements to be included in an optical element configuration; enable 605 selection and/or generation of one or more optical element configurations; implement 606 an optimization function to optimize an optical element configuration; determine 607 if an optical element configuration may meet one or more initial specifications; enable 608 one or more adjustment(s) to an optical element configuration; and determine 609 if an optical element configuration may meet one or more additional specifications.

In some examples, the instructions 603 may receive design specifications for an optical component. In some examples, design specifications of an optical component that may be received via the instructions 603 may relate to F# or F/#, numerical aperture (NA), an operating spectrum and an on-axis field. As used herein, F/# may be a ratio of a lens focal length to a diameter of a pupil at entrance. In some instances, it may indicate an efficiency of photon collection of a lens. Also as used herein, numerical aperture (NA) may refer to a cone of light that may be made from a focusing lens. In some instances, numerical aperture (NA) may refer to a range of angles in which a lens can accept light and may therefore be defined as NA=n sin (α), where n refers to refractice index and α refers to lens collection angle. In other words, numerical aperture (NA) may describe a light-gathering capability of a lens, and in some examples, may indicate a range of angles at which a lens may accept light. In some examples, an operating spectrum may include a range of operating wavelengths. Furthermore, in some examples, an on-axis field may refer to a centered field of view. It should be appreciated that, in some examples, the design specifications may include design restrictions.

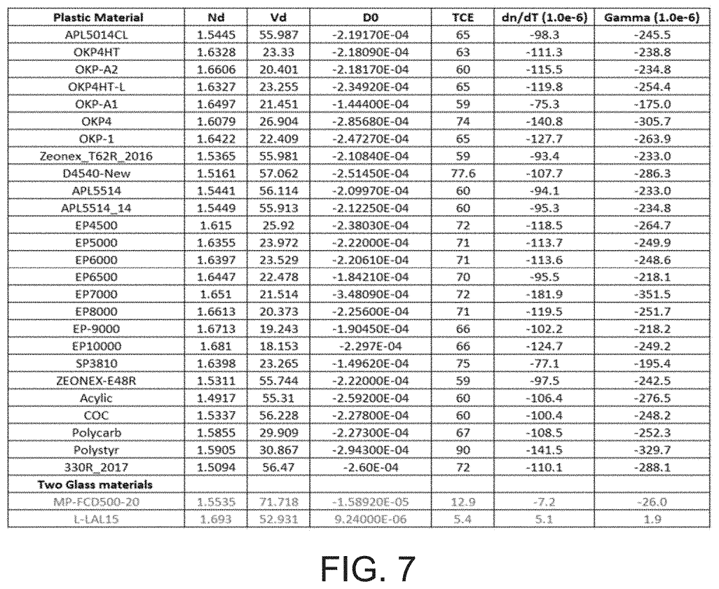

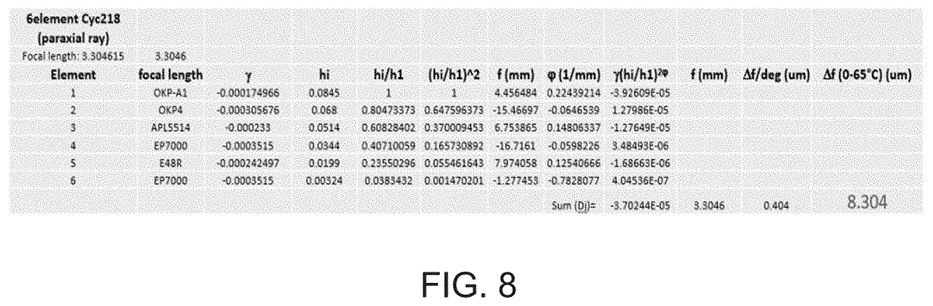

In some examples, the instructions 604 may enable selection and/or generation of one or more optical elements. In some examples, and as discussed further below, the one or more optical elements may be included in an optical element configuration. In particular, the instructions 604 may enable selection of a material for each of one or more optical elements to be included in the optical element configuration. FIG. 7 illustrates a table including various materials that may be used in fabrication of a multi-element optical component. In some examples, the instructions 604 may select a plastic material (e.g., EP5000, EP7000, etc.) or a glass material (e.g., MP-FCD500-20, L-LAL15, etc.). In some examples, the instructions 604 may select the material based on one or more associated specifications. FIG. 8 illustrates a table including specifications of various materials that may be used in fabrication/selection of one or more optical elements.

In some examples, the instructions 604 may select each of one or more optical elements with respect to an athermalization requirement. In particular, to assign a material to each of the one or more optical elements, the instructions 604 may enable selection of materials with particular thermal refractive coefficients. In some examples, the instructions 604 may enable selection of a small(er) absolute derivative dn_{T}/dT of the refractive index relative to temperature T for a positive element (i.e., an optical element that may product converging light) and large(r) derivative dn_{T}/dT of the refractive index relative to temperature T for a negative element (i.e., an optical element that may produce diverging light). Also, in some examples, for axial color correction, the instructions 604 may enable selection of a large Abbe number material for a positive element and a negative element.

In some examples, the instructions 605 may enable generation a one or more optical element configurations. In some examples, the instructions 605 may utilize one or more optical elements (e.g., as selected and/or generated via the instructions 604) to populate one or more optical element configurations. Also, in some examples, the instructions 605 may also enable the one or more optical elements to be selected with respect to an athermalization requirement. It should be appreciated that, in some examples, a first optical element and a second optical element of the one or more optical elements in an optical element configuration may be arranged to be attached (as discussed above), while in other examples, the first optical element and the second optical element of the one or more optical elements in the optical element configuration may be arranged to be separated (as discussed above).

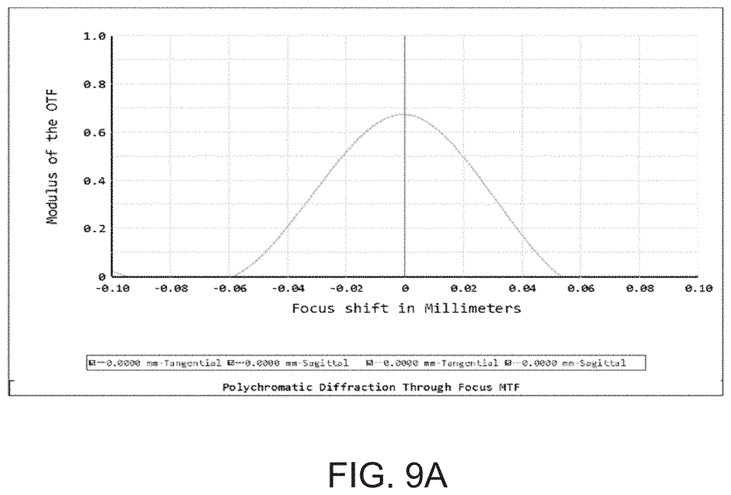

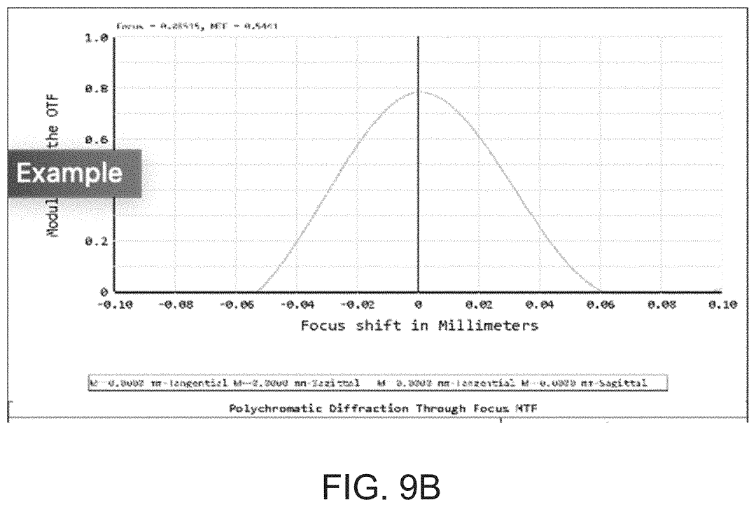

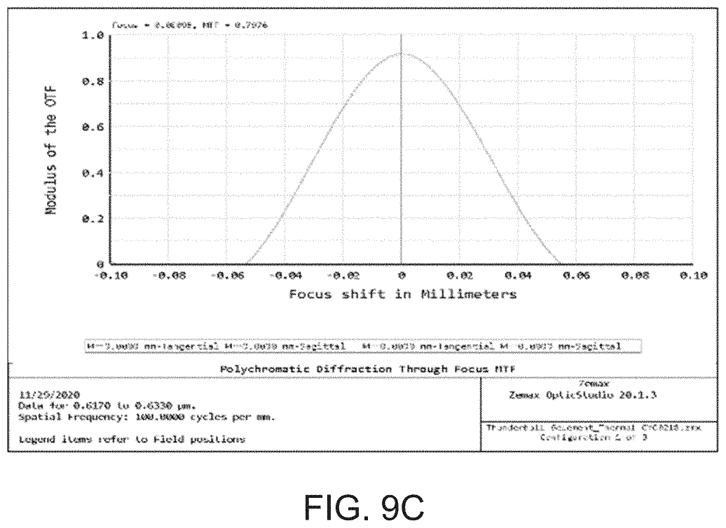

Furthermore, in some examples, the instructions 605 may enable testing of one or more optical elements of an optical element configuration with respect to a plurality of temperature settings. In some examples, the plurality of temperature settings may reflect a temperature range that an optical component may be subject to during operation. In one example, the plurality of temperature settings may include 0 degrees (0°), 35 degree (35°) and 65 degrees (65°) Fahrenheit. FIG. 9A illustrates graph of focus shift versus optical transfer function for a multi-element optical component at 0 degrees (0°). FIG. 9B illustrates graph of focus shift versus optical transfer function for a multi-element optical component at 35 degrees (35°). FIG. 9C illustrates a graph of focus shift versus optical transfer function for a multi-element optical component at 65 degrees (65°).

In some examples, the instructions 606 may implement an optimization function to optimize an optical element configuration. As used herein, an “optimization function” may include any function that may be implemented to select one or more optical elements for inclusion in an optical element configuration.

So, in some examples, the instructions 606 may implement an optimization function meet one or more athermalization requirement(s). So, in some examples, implementation of the optimization function may include selection of a focal length radius for each element. Furthermore, in some examples, the instructions 606 may implement an optimization function to compute optical power φₖᵢ, a marginal ray height hₖᵢ and a thermal refractive power γᵢ for each element to meet one or more athermalization requirement(s). Also, in some examples, the instructions 606 may implement an optimization function with respect to an effective focal length (EFFL) of an optical component. It should be appreciated that, in some examples, an optimization function may enable optimization of each optical element in an optical element configuration in order to meet one or more athermalization requirement(s). In some examples, an optimization function may also be implemented to require each optical element in an optical element configuration to meet an achromatism requirement. In one example, the achromatism requirement may be calculated as:

Δf_{FC}=0

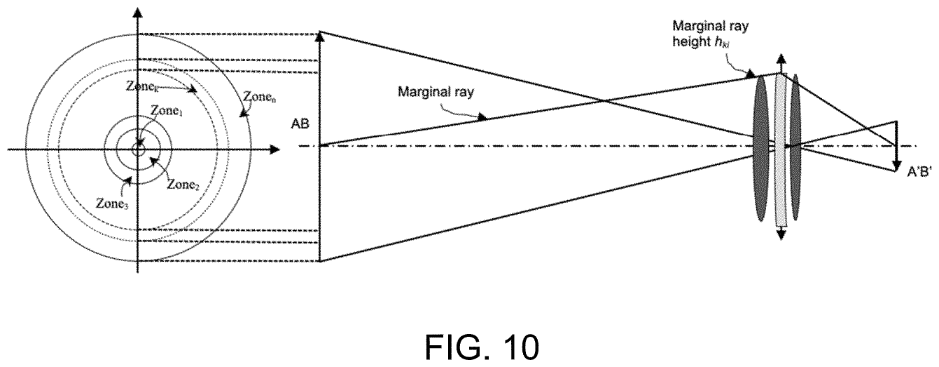

In some examples, to implement an optimization function, the instructions 606 may enable division of an object plane AB into n segments, referred to as “optical zones” or “zones” (i.e., zone₁, zone₂, . . . zoneₙ). FIG. 10 illustrates a plurality of zones including zone₁, zone₂, zoneₖ, to zoneₙ that may be utilized (e.g., by the instructions 606) in implementation of an athermalization requirement. In the example illustrated in FIG. 10, AB may be the object and A′B′ may be the image.

In some examples, the instructions 606 may implement the optimization function to compute and distribute optical power φₖᵢ, marginal ray height hₖᵢ and thermal refractive power γᵢ for each optical element to meet an athermalization requirement for a (given) zoneₖ. In some examples, the athermalization requirement may be calculated as:

$$- {( \frac{1}{{φ}_{k}} )}^{2} {\sum }_{i}^{n} {( \frac{{h}_{k i}}{{h}_{k 1}} )}^{2} {γ}_{i} {φ}_{k i} - α L = 0 .$$

In some examples, φₖ may be an optical power for all optical elements at a zone k, L may be a lens barrel length for the optical element configuration, α may a barrel coefficient of thermal expansion (CTE) and hₖ₁ may be a marginal ray height at zone k for a first element. Also, in some examples, the instructions 606 may calculate a coefficient of thermal expansion (CTE) for a lens as follows:

$${α}_{lens} - \frac{\frac{{dn}_{T}}{dT}}{{n}_{0} - 1} .$$

In some examples, n₀ may be a refractive index of the lens and dn_{T}/dT may be a derivative of the refractive index relative to temperature T. Also, in some examples, the lens barrel may be made of a polycarbonate variant.

In some examples, the instructions 606 may enable optimization with respect to athermalization for each of zone₁, zone₂, zoneₖ . . . zoneₙ (i.e., to a completion of all zones). So, in some examples, the instructions 606 may implement the optimization function to compute an athermalization characteristic for zone₁, followed by a computation an athermalization characteristic for zone₂, followed by a computation an athermalization characteristic for zoneₖ, and further followed by an athermalization computation for zoneₙ. And in some examples, upon satisfaction of one or more athermalization requirements for each of zone₁, zone₂, zoneₖ . . . zoneₙ, the instructions 606 may determine that an athermalization requirement for the optical element configuration may be met.

In some examples, the instructions 607 may determine if an optical element configuration may meet (i.e., satisfy) one or more initial specifications. In some examples, the initial specifications may include athermalization and achromatic specifications. Moreover, in some examples, if the instructions 607 may determine that the optical element configuration may not meet the athermalization and achromatic specifications, the instructions 607 may return processing (e.g., to the instructions 604) for continued selection and/or generation of optical elements.

In some examples, the instructions 608 may enable one or more adjustment(s) to an optical element configuration. In some examples, the instructions 608 may enable adjustments based on requirements related to resolution, distortion, and field of view (FOV), etc. In addition, in some examples, the instructions 608 may enable corrections for spherical aberration, coma, astigmatism, field curvature, distortion, lateral and axial color, and/or other similar conditions.

In some examples, the instructions 609 may determine if an optical element configuration may meet one or more additional specifications. In some examples, the additional specifications may include one or more design specifications (e.g., as received via the instructions 603). In some examples, the one or more additional specifications may include generation and/or determination of a modulation transfer function (MTF), a spot diagram and distortion. As used herein, a spot diagram may indicate an image produced by an optical system if the object were to be a spot of light. In some examples, the implementation and/or satisfaction of the one or more additional specifications may require multiple iterations. In some examples, if the instructions 609 may determine that the optical element configuration may not meet the additional specifications, the instructions 609 may return processing (e.g., to the instructions 604) for continued selection and/or generation of optical elements. On the other hand, in some examples, if the instructions 609 may determine that the optical element configuration may meet the design specifications, processing may end.

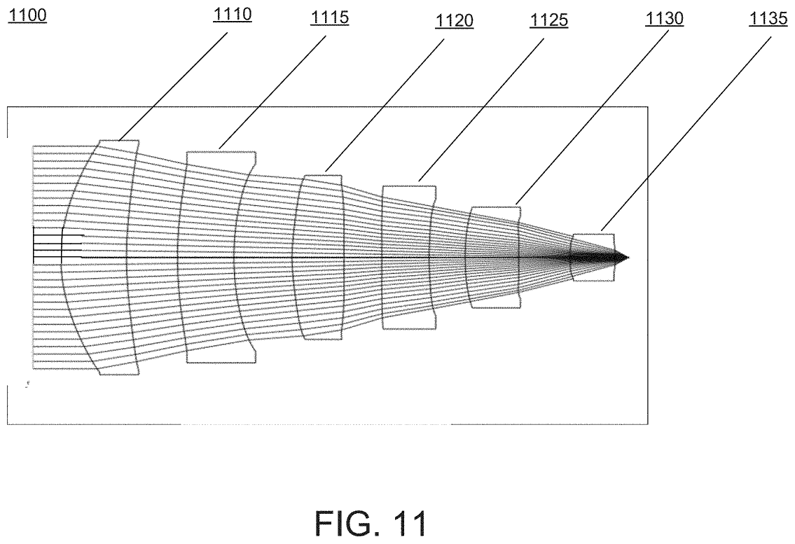

FIG. 11 illustrates an example of an optical element configuration 1100. In some examples, the optical element configuration 1100 may include a first optical element 1110, a second optical element 1115, a third optical element 1120, a fourth optical element 1125, a fifth optical element 1130 and a sixth optical element 1135 (collectively “elements”). In some examples, the first optical element 1110 may include at least one concave face, the second optical element 1115 may include at least one convex face, the third optical element 1120 may include at least one concave face, the fourth optical element 1125 may include at least one convex face, the fifth optical element 1130 may include at least one concave face and the sixth optical element 1135 may be substantially square in shape. In some examples, the first optical element 1110 may be wider than the second optical element 1115, the second optical element 1115 may be wider than the third optical element 1120, the third optical element 1120 may be wider than the fourth optical element 1125, the fourth optical element 1125 may be wider than the fifth optical element 1130 and the fifth optical element 1130 may be wider than the sixth optical element 1135.

In some examples, a (total) length of the optical elements may be approximately 4.0 millimeters (mm). Also, in some examples, a (total) width of the optical elements may be approximately 2.0 millimeters (mm). Furthermore, in some examples, a distance between each element may be approximately 0.2-0.3 millimeters (mm).

In some examples, the first optical element 1110 may be made of OKP-A1, the second optical element 1115 may be made of OKP4, the third optical element 1120 may be made of APF5514, the fourth optical element 1125 may be made of E48R, the fifth optical element 1130 may be made of EP7000 and a sixth optical element 1135 may be made of EP8000. In other examples, the first optical element 1110 may be made of PMMA, the second optical element 1115 may be made of OKP4, the third optical element 1120 may be made of APF5514, the fourth optical element 1125 may be made of E48R, the fifth optical element 1130 may be made of EP7000 and a sixth optical element 1135 may be made of EP8000.

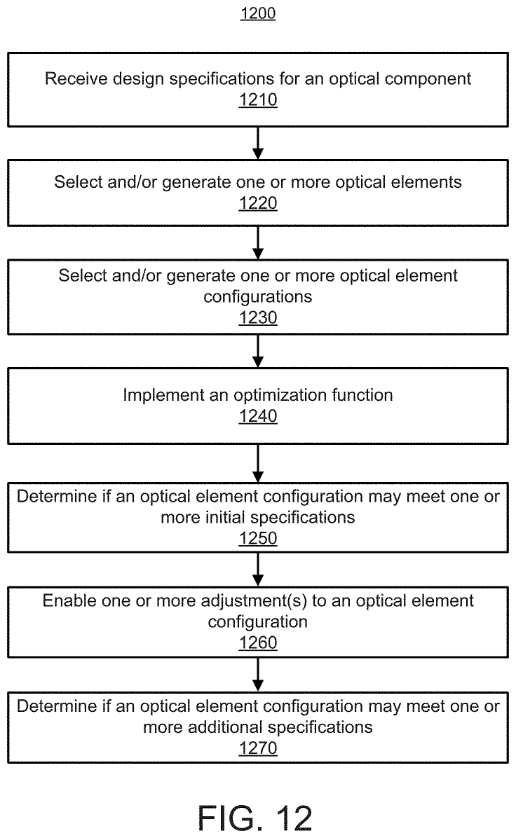

FIG. 12 illustrates a method to design optical components, including multi-element optical components, that provide may passive athermalization and aberration correction over an entire field of view (FOV), according to an example. The method 1200 is provided by way of example, as there may be a variety of ways to carry out the method described herein. Each block shown in FIG. 12 may further represent one or more processes, methods, or subroutines, and one or more of the blocks may include machine-readable instructions stored on a non-transitory computer-readable medium and executed by a processor or other type of processing circuit to perform one or more operations described herein. Although the method 1200 is primarily described as being performed by system 600 as shown in FIGS. 6A-B, the method 1200 may be executed or otherwise performed by other systems, or a combination of systems.

Reference is now made with respect to FIG. 12. At 1210, the processor 601 may receive design specifications for an optical component. In some examples, the design specifications may relate to F# or F/#, numerical aperture (NA), an operating spectrum and an on-axis field.

At 1220, the processor 601 may select and/or generate one or more optical elements to be included in an optical element configuration. In some examples, the processor 601 may select and/or generate each of the one or more optical elements with respect to an athermalization requirement. In some examples, the processor 601 may select and/or generate a plastic material (e.g., EP5000, EP7000, etc.) or a glass material (e.g., MP-FCD500-20, L-LAL15, etc.).

At 1230, the processor 601 may select and/or generate one or more optical element configurations. Furthermore, in some examples, the processor 601 may enable testing of one or more optical elements of an optical element configuration with respect to a plurality of temperature settings. In one example, the plurality of temperature settings may include 0 degrees (0°), 35 degree (35°) and 65 degrees (65°) Fahrenheit.

At 1240, the processor 601 may implement an optimization function to optimize an optical element configuration. In some examples, the processor 601 may implement an optimization function meet one or more athermalization requirement(s). In some examples, to implement an optimization function, the processor 601 may enable division of an object plane AB into n segments, referred to as “zones” (i.e., zone₁, zone₂, . . . zoneₙ).

At 1250, the processor 601 may determine if an optical element configuration may meet one or more initial specifications. In some examples, the initial specifications may include athermalization and achromatic specifications.

At 1260, the processor 601 enable one or more adjustment(s) to an optical element configuration. In some examples, the processor 601 may enable adjustments related to resolution, distortion, and field of view (FOV).

At 1270, the processor 601 may determine if an optical element configuration may meet one or more additional specifications. In some examples, if the processor 601 may determine that the optical element configuration may not meet the additional specifications, the processor 601 may return processing for continued selection and/or generation of optical elements. On the other hand, in some examples, if the processor 601 may determine that the optical element configuration may meet the design specifications, then processing may end.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. An apparatus, comprising:
a plurality of optical elements, the plurality of optical elements including:
a first optical element having at least one concave face;
a second optical element having at least one convex face, wherein the first optical element is wider than the second optical element;
a third optical element having at least one concave face, wherein the second optical element is wider than the third optical element;
a fourth optical element having at least one convex face, wherein the third optical element is wider than the fourth optical element;
a fifth optical element having at least one concave face, wherein the fourth optical element is wider than the fifth optical element; and
a sixth optical element having at least one substantially square shape, wherein the fifth optical element is wider than the sixth optical element.

2. The system of claim 1, wherein a total length of the plurality of optical elements is approximately 4.0 millimeters (mm) and a total width of the plurality of optical elements is approximately 2.0 millimeters (mm).

3. The system of claim 1, wherein a distance between each element of the plurality of optical elements is approximately 0.2-0.3 millimeters (mm).

4. The method of claim 1, wherein the first optical element is made of OKP-A1, the second optical element is made of OKP4, the third optical element is made of APF5514, the fourth optical element is made of E48R, the fifth optical element is made of EP7000 and a sixth optical element is made of EP8000.

5. The method of claim 1, wherein the first optical element is made of PMMA, the second optical element is made of OKP4, the third optical element is made of APF5514, the fourth optical element is made of E48R, the fifth optical element is made of EP7000 and a sixth optical element is made of EP8000.

6. A method for designing optical components to provide passive athermalization and aberration correction, comprising:
receiving one or more design specifications for an optical component;
selecting one or more optical elements to be included in the optical component based on the design specifications;
generating one or more optical element configurations utilizing the one or more optical elements; and
implementing an optimization function to optimize the one or more optical element configurations.

7. The method of claim 6, wherein the optimization function is implemented with respect to an effective focal length (EFFL) of the optical component.

8. The method of claim 6, wherein the optimization function is implemented to compute optical power φₖᵢ, marginal ray height hₖᵢ and thermal refractive power γᵢ for each of the one or more optical elements to meet an athermalization requirement for each of a plurality of optical zones.

9. The method of claim 8, where an athermalization requirement for a zone k of the plurality of optical zones is:
$$- {( \frac{1}{{φ}_{k}} )}^{2} {\sum }_{i}^{n} {( \frac{{h}_{k i}}{{h}_{k 1}} )}^{2} {γ}_{i} {φ}_{k i} - α L = 0 .$$

10. The method of claim 6, further including:
determining if the one or more optical element configurations meet one or more initial specifications;
enabling one or more adjustments to the one or more optical element configurations based on the one or more initial specifications; and
determining if the one or more optical element configurations meet one or more additional specifications.

11. The method of claim 10, wherein the initial specifications include specifications associated with athermalization and achromatism.

12. The method of claim 6, wherein the selecting the one or more optical element configurations includes testing the one or more optical elements with respect to a plurality of temperature settings.

13. The method of claim 12, wherein the plurality of temperature settings includes 0 degrees Fahrenheit (0° F.), 35 degrees Fahrenheit (35° F.) and 65 degrees Fahrenheit (65° F.).

14. The method of claim 6, wherein a first optical element of the one or more optical elements is plastic and a second optical element of the one or more optical elements is glass.

15. A non-transitory computer-readable storage medium having an executable stored thereon, which when executed instructs a processor to:
receive one or more design specifications for an optical component;
select, based on the one or more design specifications, one or more optical elements to be included in the optical component;
generate one or more optical element configurations utilizing the one or more optical elements;
implement an optimization function to optimize the one or more optical element configurations;
determine if the one or more optical element configurations satisfy one or more initial specifications; and
enable one or more adjustments to the one or more optical element configurations based on the one or more initial specifications.

16. The non-transitory computer-readable storage medium of claim 15, wherein the design specifications include one or more of F#, numerical aperture (NA), an operating spectrum and an on-axis field.

17. The non-transitory computer-readable storage medium of claim 15, wherein to generate the one or more optical elements, the executable when executed further instructs the processor to select a material for each of the one or more optical elements.

18. The non-transitory computer readable storage medium of claim 15, wherein the selection of one or more optical elements is based on an athermalization requirement.

19. The non-transitory computer-readable storage medium of claim 15, wherein to select the one or more optical element configurations, the executable when executed further instructs the processor to test the one or more optical elements with respect to a plurality of temperature settings.

20. The non-transitory computer-readable storage medium of claim 15, wherein the optimization function includes selection of a focal length radius for each of the one or more optical elements.
